(19) United States
(12) Patent Application Publication
(10) Pub. No.: US 2025/0323802 A1
(43) Pub. Date: Oct. 16, 2025

(54) Systems and Methods for Bitstream Authentication

(71) Applicants: Michael Neve de Mevergnies, Guidel (FR); Geoffrey Strongin, Tigard, OR (US); Aditya Katragada, Austin, TX (US); Andrew Draper, Chesham (GB); Anthony Cartolano, Cedar Park, TX (US)

(72) Inventors: Michael Neve de Mevergnies, Guidel (FR); Geoffrey Strongin, Tigard, OR (US); Aditya Katragada, Austin, TX (US); Andrew Draper, Chesham (GB); Anthony Cartolano, Cedar Park, TX (US)

(21) Appl. No.: 19/250,470

(22) Filed: Jun. 26, 2025

(51) Int. Cl. H04L 9/32; G06F 21/16; H04L 9/08

(52) U.S. Cl. CPC H04L 9/3247; G06F 21/16; H04L 9/0825; H04L 9/0869; H04L 9/3236; H04L 9/3271; H04L 2209/608

(57) ABSTRACT

A method includes receiving a bitstream including a signature associated with a private key, and detecting a first watermark of the bitstream, wherein the first watermark is associated with a first public key. The method also includes loading the bitstream based on determining that the first public key corresponds to a second public key and the private key and that the first public key is validated based on a validation value.

### BACKGROUND

This disclosure relates to systems and methods for authenticating a bitstream (e.g., configuration data) before loading the bitstream on an integrated circuit device, such as a field programmable gate array (FPGA).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices and provide a variety of functionality. Many integrated circuits include programmable logic circuitry that may be configured with a hardware system design to implement hardware designs that may perform a wide variety of different functions. An integrated circuit may be designed or, in the case of an FPGA, may be configured, based on a bitstream (e.g., configuration data) loaded onto the FPGA. However, if the bitstream were stolen and loaded onto separate FPGAs, this could enable hardware cloning and/or device counterfeiting. Encryption may be employed to provide protection for the bitstream, but a sophisticated adversary might also steal a key (e.g., decryption key) associated with the encryption.

### BRIEF DESCRIPTION OF THE DRAWINGS

Various aspects of this disclosure may be better understood upon reading the following detailed description and upon reference to the drawings in which:

FIG. 1 is a block diagram of a system used to program a system design onto an integrated circuit device, according to embodiments of the present disclosure;

FIG. 2 is a block diagram of an example integrated circuit device that may be programmed with a system design, according to embodiments of the present disclosure;

FIG. 3 is a diagram illustrating a transfer of the integrated circuit device from a manufacturer to a customer to an end user, according to embodiments of the present disclosure;

FIG. 4 is a flow diagram of processes performed by a device controller of the integrated circuit device to load a bitstream, according to embodiments of the present disclosure;

FIG. 5 is a flowchart of a method for setting a validated bit to a public key, according to embodiments of the present disclosure;

FIG. 6 is a flowchart of a method for loading the bitstream for configuration of the integrated circuit device, according to embodiments of the present disclosure; and

FIG. 7 is a block diagram of a data processing system that may incorporate the systems and methods of this disclosure, according to embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

This disclosure relates to systems and methods for authenticating a bitstream (e.g., configuration data) before loading the bitstream on an integrated circuit device, such as an FPGA. The integrated circuit device (e.g., device controller of the integrated circuit device) may enter a provisioning mode. For example, a provisioning entity may cause the integrated circuit device to enter the provisioning mode by providing a request for the integrated circuit device to provision a public key. It should be noted that the public key may have been previously generated by a separate entity along with a corresponding private key. Thus, in some embodiments, the public key may be provided to the provisioning entity and/or stored on the integrated circuit device, while the corresponding private key remains stored in a secure facility.

The integrated circuit device may generate a random nonce (e.g., challenge, random value) and transmit the random nonce to the provisioning entity for signature. For example, the integrated circuit device may transmit the random nonce for the provisioning entity to sign the random nonce with the corresponding private key. The integrated circuit device may then receive the signed random nonce from the provisioning entity and perform a digital signature verification of a signature of the signed random nonce. For example, the integrated circuit device may employ the public key to verify the signature of the signed random nonce was signed with the corresponding private key.

Moreover, the integrated circuit device may determine that a hash of the public key to be provisioned matches a hash of a public key that is stored on the integrated circuit device (e.g., previously provisioned public key). If the hash of the public key to be provisioned matches the hash of the public key that is stored, then the integrated circuit device may set a validation value (e.g., assert a validation flag, set a validation bit) based on validating the public key to be provisioned. Moreover, the integrated circuit device may provision the public key provided by the provisioning entity.

The integrated circuit device may receive a bitstream that includes the public key, the digital signature (e.g., generated based on the corresponding private key), and a watermarked user design. The watermarked user design may include one or more watermarks that the integrated circuit device may employ when determining whether to load the bitstream for configuration. A first watermark of the one or more watermarks may include a transformation (e.g., full hash, truncated hash) of the public key. Thus, the integrated circuit device may detect the first watermark and determine whether the transformation of the public key in the first watermark corresponds to the public key stored on the integrated circuit device.

Moreover, the integrated circuit device may detect a second watermark of the one or more watermarks in the bitstream that indicates a valid public key must be employed for configuration of the bitstream. Thus, the integrated circuit device may perform a bit check for the validation bit to determine whether the public key was validated. If the first watermark corresponds to the public key stored on the integrated circuit device, and if the validation value is set indicating that the public key was validated, then the integrated circuit device may load the bitstream into its programmable logic circuitry for configuration.

Accordingly, by signing the bitstream with the private key, and provisioning the integrated circuit device with the public key of the provisioning entity based on validating the public key, the integrated circuit device may verify that the signature of the bitstream (e.g., with the private key) corresponds to the public key that is provisioned on the integrated circuit device. As such, by employing the public key and the corresponding private key during authentication, the integrated circuit device may provide additional layers of security for the integrated circuit device to prevent counterfeiting and/or hardware cloning. That is, embodiments described herein may prevent counterfeiting and/or hardware cloning because a counterfeiter may be unable to sign the bitstream with a valid private key that corresponds to the public key.

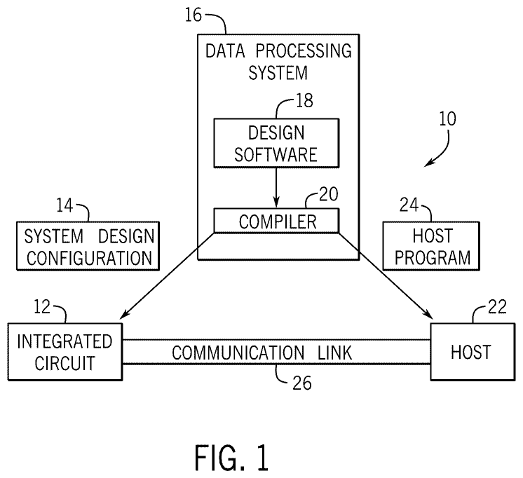

FIG. 1 illustrates a block diagram of a system 10 that may be used to program an integrated circuit device 12, such as an FPGA (e.g., Agilex™, Stratix®, Arria®, MAX®, or Cyclone® devices by Altera® Corporation), with a system design using a system design configuration 14. Note that, while this disclosure largely refers to the integrated circuit device 12 as being a programmable logic device, such as an FPGA, in some embodiments, the integrated circuit device 12 may also be a one-time programmable device or structured application specific integrated circuit (ASIC), such as an Intel® eASIC™ device by Intel® Corporation. In other examples, the integrated circuit device 12 may be any suitable integrated circuit that is manufactured to have a particular system design with circuitry to perform desired data processing operations. The integrated circuit device 12 may be a single monolithic integrated circuit or a multi-die system of integrated circuits. The integrated circuit device 12 may include a single integrated circuit, multiple integrated circuits in a package, or multiple integrated circuits in multiple packages communicating remotely (e.g., via wires or traces) and may be referred to as an integrated circuit device or an integrated circuit system whether formed from a single integrated circuit or multiple integrated circuits in a package.

A designer may desire to implement the system design configuration 14 (sometimes referred to as a circuit design or configuration) to perform a wide variety of possible operations on the integrated circuit device 12. In some cases, the designer may specify a high-level program to be implemented, such as an OPENCL® program that may enable the designer to more efficiently and easily provide programming instructions to configure a set of programmable logic cells for the integrated circuit device 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

In a configuration mode of the integrated circuit device 12, a designer may use a data processing system 16 (e.g., a computer including a data processing system having a processor and memory or storage) to implement high-level designs (e.g., a system user design) using design software 18 (e.g., executable instructions stored in a tangible, non-transitory, computer-readable medium such as the memory or storage of the data processing system 16), such as a version of Altera® Quartus® by Altera Corporation. The data processing system 16 may use the design software 18 and a compiler 20 to convert the high-level program into a lower-level description (e.g., a configuration program, a bitstream) as the system design configuration 14. The compiler 20 may provide machine-readable instructions representative of the high-level program to a host 22 and the system design configuration 14 to the integrated circuit device 12.

Additionally or alternatively, the host 22 running the host program 24 may control or implement the system design configuration 14 onto the integrated circuit device 12. For example, the host 22 may communicate instructions from the host program 24 to the integrated circuit device 12 via a communications link 26 that may include, for example, direct memory access (DMA) communications or peripheral component interconnect express (PCIe) communications. The designer may use the design software 18 to generate and/or to specify a low-level program, using low-level tools such as the low-level hardware description languages described above. Further, in some embodiments, the system 10 may be implemented without a separate host 22 or host program 24. Thus, embodiments described herein are intended to be illustrative and not limiting.

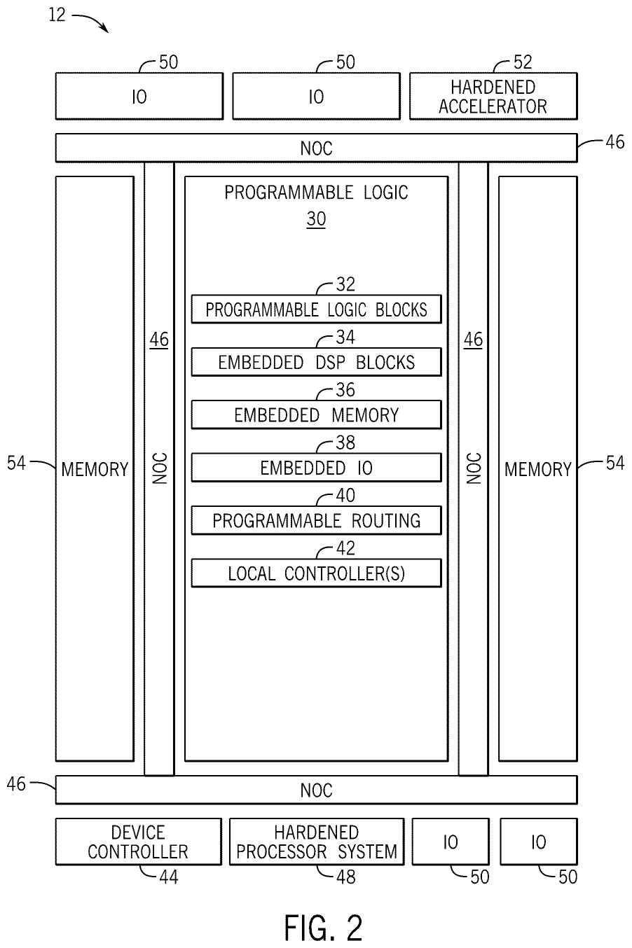

The integrated circuit device 12 may take any suitable form that may implement the system design configuration 14. In one example shown in FIG. 2, the integrated circuit device 12 may include programmable logic circuitry 30, which include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table, effectively enabling any the programmable logic blocks 32 to implement any desired logic circuitry when configured with the system design configuration 14. The programmable logic blocks 32 and are sometimes referred to as logic array blocks (LABs) or configurable logic blocks (CLBs).

The embedded DSP blocks 34, embedded memory blocks 36, and embedded IO blocks 38 may be distributed around the programmable logic blocks 32. For example, there may be several columns of programmable logic blocks 32 for every column of DSP blocks 34, column of embedded memory blocks 36, or column of embedded IO blocks 38. The embedded DSP blocks 34 may include “hardened” circuits that are specialized to efficiently perform certain arithmetic operations. This is in contrast to “soft logic” circuits that may be programmed into the programmable logic blocks 32 to perform the same functions, but which may not be as efficient as the hardened circuits of the DSP blocks 34. The embedded memory blocks 36 may include dedicated local memory (e.g., blocks of 20 kB, blocks of 1 MB). The embedded IO blocks 38 may allow for inter-die or inter-package communication. The embedded DSP blocks 34, embedded memory blocks 36, and embedded IO blocks 38 may be accessible to the programmable logic blocks 32 using the programmable routing 40.

The various functional blocks of the programmable logic circuitry 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic circuitry 30 resources on the integrated circuit device 12 into logic sectors, logic array blocks, logic elements, or adaptive logic modules is merely illustrative. In general, the integrated circuit device 12 may include functional logic blocks of any suitable size and type, which may be organized in accordance with any suitable logic resource hierarchy. Indeed, there may be other functional blocks (e.g., other embedded application specific integrated circuit (ASIC) blocks) than those shown in FIG. 2.

Before continuing, it may be noted that the programmable logic circuitry 30 of the integrated circuit device 12 may be controlled by programmable memory elements sometimes referred to as configuration random access memory (CRAM). Memory elements may be loaded with configuration data (also called programming data or a configuration bitstream) that represents the system design configuration 14. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit device 12. The device controller 44 may include any suitable logic circuitry to control and/or program the programmable logic circuitry 30 or other elements of the integrated circuit device 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally or alternatively, the device controller 44 may include a hardware finite state machine (FSM). The device controller 44 may provide other functions, such as serving as a platform for virtual machines that may manage the operation of the integrated circuit device 12.

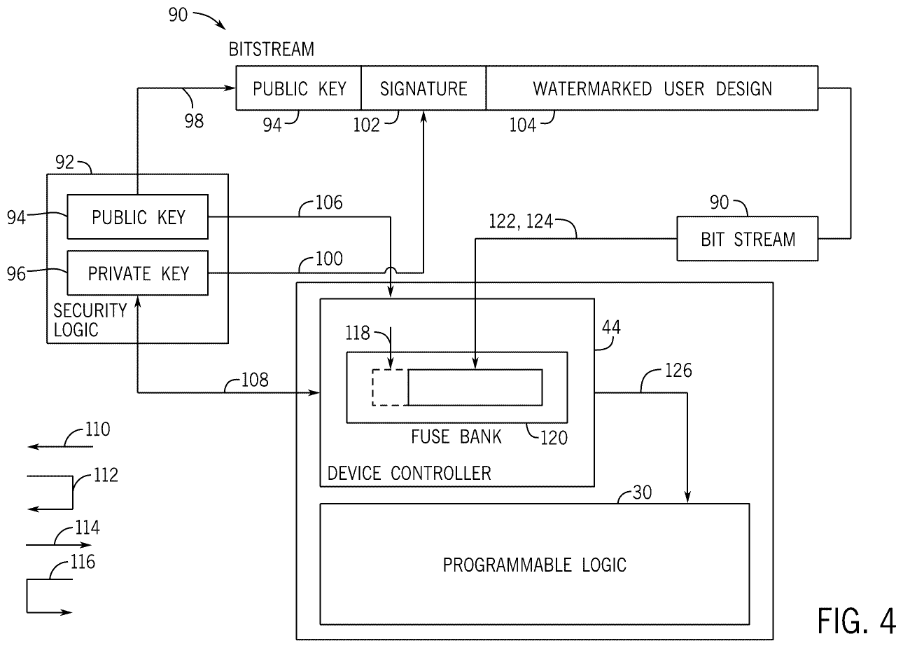

For example, the device controller 44 may receive a bitstream and verify a digital signature of the bitstream. The device controller 44 may also detect a first watermark in the bitstream including a transformation of a public key and determine whether the first watermark corresponds to the public key on the integrated circuit device 12. Moreover, the device controller 44 may detect a second watermark in the bitstream, which may indicate that a valid public key must be used for configuration of the bitstream. Therefore, the device controller 44 may determine whether a validation value is set in the bitstream. Moreover, the device controller 44 may load the bitstream for configuration in response to determining that the validation value is set. Additional details regarding the device controller 44 loading the bitstream will be described below with respect to FIGS. 4-7.

A network-on-chip (NOC) 46 may connect the various elements of the integrated circuit device 12. The NOC 46 may provide rapid, packetized communication to and from the programmable logic circuitry 30 and other blocks, such as a hardened processor system 48, high-speed input-output (IO) blocks 50, a hardened accelerator 52, and local device memory 54. The integrated circuit device 12 may include the hardened processor system 48 when the integrated circuit device 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit device 12. The high-speed IO blocks 50 may enable communication using any suitable communication protocol(s) with other devices outside of the integrated circuit device 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic circuitry 30.

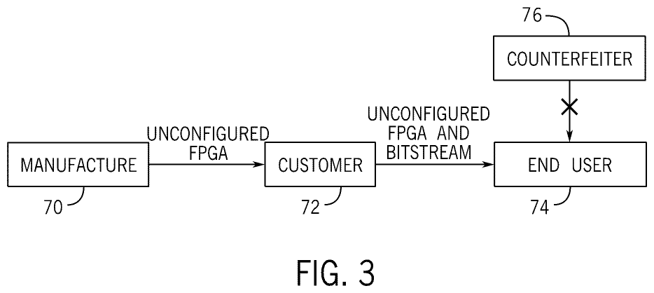

FIG. 3 is a diagram illustrating a transfer of the integrated circuit device 12, such as an FPGA, from a manufacturer 70 (e.g., distributor) to a customer 72 (e.g., designer) to an end user 74. The manufacturer 70 may manufacture an unconfigured FPGA (e.g., unprogrammed FPGA, blank FPGA, initial-state FPGA). For example, the unconfigured FPGA may not include any particular logic design. The manufacturer may then provide the FPGA to the customer 72.

The customer 72 may receive the unconfigured FPGA and develop a design for the unconfigured FPGA. Additionally, the customer 72 may compile the design into a bitstream (e.g., configuration data). The customer 72 may generate a public key with a corresponding private key. Further, the customer 72 may encrypt the bitstream based on the public key and the corresponding private key. In some embodiments, the customer 72 may employ security logic (e.g., high-security module, security circuitry, secure facility, security database) at a secure facility to generate and/or store the private key at a site of the customer 72. Indeed, the customer 72 may employ the security logic to generate, store, and/or manage the public key, the corresponding private key, and/or any other suitable cryptographic keys. It should be noted that the security logic may include hardware elements (including circuitry), software elements (including machine-executable instructions) or a combination of both hardware and software elements (which may be referred to as the logic). The customer 72 may provide the public key (e.g., to the end user 74) to enable use of the public key outside of the security logic. Alternatively, the private key may remain stored in the security logic (e.g., not provided to the end user 74). The customer 72 may provide the unconfigured FPGA and the encrypted bitstream to the end user 74.

The end user 74 may receive the unconfigured FPGA and the encrypted bitstream. The end user 74 may then begin a provisioning process for the unconfigured FPGA based on the encrypted bitstream. For example, the end user 74 may attempt to load the encrypted bitstream onto the unconfigured FPGA. In some embodiments, the unconfigured FPGA may be unprovisioned (e.g., not provisioned at all). In other embodiments, the unconfigured FPGA may be partially provisioned with a number of additional public keys. The end user 74 may employ the device controller 44 during the provisioning process.

To prevent a counterfeiter 76 from stealing and/or loading the encrypted bitstream onto a separate FPGA to clone hardware and/or create a counterfeit device, the device controller 44 may verify a digital signature of the bitstream by employing a validated the public key prior to loading the encrypted bitstream. The encrypted bitstream may be signed with the private key. The end user 74 may begin the provisioning process for the unconfigured FPGA with the public key (e.g., received from the customer 72), which may involve validating the public key.

The device controller 44 may detect a first watermark in the bitstream containing a transformation (e.g., hash) of the public key and compare it to a public key stored in the device controller 44. Moreover, the device controller 44 may detect a second watermark in the bitstream indicating that the valid public key is to be used for configuration of the bitstream. If the transformation of the public key corresponds to the stored public key, and the bitstream includes a validation value indicating that the valid public key is to be used, then the device controller 44 may load the bitstream for configuration.

By signing the bitstream with the private key, and provisioning the FPGA with the public key, the FPGA may verify that the signature of the bitstream (e.g., with the private key) corresponds to the public key that is provisioned on the FPGA. As such, by employing the public key and the corresponding private key during verification, the device controller 44 may provide additional layers of security for the FPGA to prevent counterfeit devices and/or hardware cloning.

FIG. 4 is a flow diagram of processes performed by the device controller 44 of the integrated circuit device 12 to load a bitstream 90 for configuration of the integrated circuit device 12. For example, the customer 72 may compile a design for the integrated circuit device 12 into the bitstream 90. Additionally, the customer 72 may employ security logic 92 to generate any suitable number of cryptographic keys for the bitstream 90. For example, the security logic 92 may generate a public key 94 (e.g., shared with the end user 74) and a corresponding private key 96 (e.g., not shared with the end user 74). It should be noted that while the customer 72 is described as employing the security logic 92, any other suitable user (e.g., the manufacturer 70, the end user 74) may employ the security logic 92 to generate the public key 94 and the corresponding private key 96.

In process 98, the security logic 92 may encode (e.g., embed) the public key 94 into the bitstream 90. Moreover, in process 100, the security logic 92 may generate a signature 102 (e.g., digital signature) based on the private key 96. For example, the security logic 92 may hash the bitstream 90 (e.g., apply a cryptographic hash function to the bitstream 90) and sign the hash with the private key 96 to generate the signature 102. As such, the signature 102 may be encrypted with the private key 96. The bitstream 90 may also include a watermarked user design 104 (e.g., compiled by the customer 72). The watermarked user design 104 may include one or more watermarks (e.g., data embedded within the bitstream 90) to enable the device controller 44 to verify the bitstream 90 before loading the bitstream 90.

In process 106, the device controller 44 may enter a provisioning mode. For example, the end user 74 may cause the device controller 44 to enter the provisioning mode with the public key 94 to be provisioned by the device controller 44. After entering the provisioning mode, the device controller 44 may validate the public key 94 that is to be provisioned. In process 108, the device controller 44 may initiate a challenge response protocol to validate the public key 94 that is to be provisioned.

In process 110, the device controller 44 may generate a random nonce (e.g., random value, challenge) as part of the challenge response protocol. Further, in process 112, the device controller 44 may transmit the random nonce to the end user 74 for signature with the private key 96. For example, the end user 74 may hash the random nonce and encrypt the hash with the private key 96 to create a signature of the random nonce. It should be noted that the signature of the nonce may be created by a user in possession of the private key 96. Therefore, by signing the random nonce, the end user 74 may prove that they are in possession of the private key 96.

In process 114, the device controller 44 receives a response from the end user 74, which includes the signed random nonce. Moreover, in process 116, the device controller 44 may verify the signed random nonce with the public key 94. The device controller 44 may verify the signed random nonce to determine that the end user 74 is in possession of the private key 96 that corresponds to the public key 94. To elaborate, the device controller 44 may use the public key 94 to decrypt the signed random nonce and generate a hash of the signed random nonce. The device controller 44 may then verify the signed random nonce by determining if there is a match between the hash of the signed random nonce and the hash the previously transmitted random nonce.

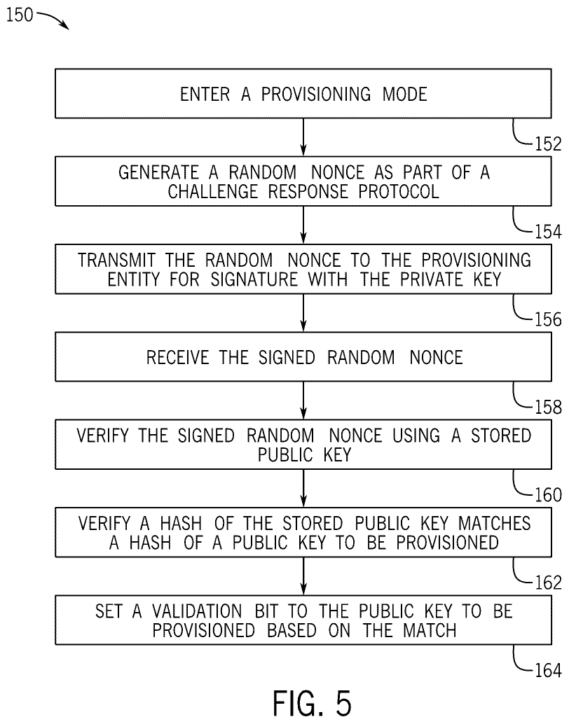

The device controller 44 may verify a hash of a stored public key (e.g., of one or more previously provisioned public keys) matches a hash of the public key 94 that is to be provisioned by comparing the hash of the stored public key to the hash of the public key 94 that is to be provisioned. Additionally, in process 118, if the device controller 44 determines the hash of the public key 94 that is to be provisioned matches the hash of the stored public key, then the device controller 44 sets (e.g., adds) a validation value (e.g., flag) to the public key to be provisioned that indicates that the public key to be provisioned is valid. Further, the device controller 44 may provision the public key 94 and store the public key 94 in a fuse bank 120 (e.g., memory including a set of programmable fuses), which may be a one-time programmable memory of the device controller 44. It should be noted that the validation value may include a one-time programmable value that is programmed in the fuse bank 120. Additional details regarding setting the validation value for public key validation will be described below with respect to FIG. 5.

In process 122, the device controller 44 may receive the bitstream 90. In process 124, the device controller 44 may verify the signature 102 of the bitstream 90. As described herein, the security logic 92 may generate the signature 102 based on the private key 96. Thus, the device controller 44 may verify the signature 102 based on determining that the public key 94 stored on the device controller 44 (e.g., provisioned by the end user 74) corresponds to the private key 96 associated with the signature 102.

As described herein, the bitstream 90 may include the watermarked user design 104, which may include the one or more watermarks encoded into the bitstream 90. After verifying the signature 102, the device controller 44 may execute watermark detection. For example, a first watermark of the one or more watermarks may contain the public key 94 or a transformation (e.g., full hash, truncated hash) of the public key 94. Thus, the device controller 44 may detect the first watermark and determine whether the public key 94 or the transformation of the public key 94 corresponds to the public key 94 stored in the fuse bank 120.

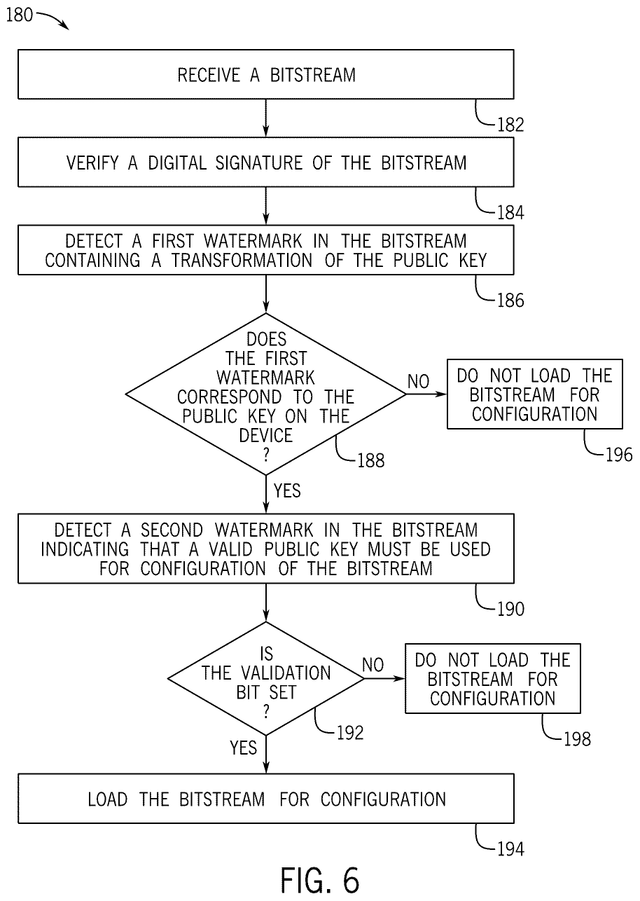

Moreover, the device controller 44 may detect a second watermark of the one or more watermarks that includes an indication of a condition that a valid public key must be employed for configuration of the bitstream 90. Thus, the device controller 44 may perform a bit check for the validation value to determine whether the public key 94 was validated. Further, the device controller 44 may compare a hash of the public key 94 of the bitstream 90 to a hash of the public key 94 stored in the fuse bank 120 to determine if they match. If the hash of the public key 94 of the bitstream 90 matches the hash of the public key 94, which includes the validation value indicating that the stored public key 94 is valid, then the device controller 44 may determine the public key 94 of the bitstream 90 is also valid. If the first water mark corresponds to the public key 94 and the validation value is set, then in process 126, the device controller 44 loads the bitstream 90 into the programmable logic circuitry 30 of the integrated circuit device 12 for configuration. Additional details regarding loading the bitstream 90 for configuration of the integrated circuit device 12 will be described below with respect to FIG. 6.

With the foregoing in mind, FIG. 5 is a flowchart of a method 150 for setting the validated bit to the public key 94. For example, the device controller 44 of the integrated circuit device 12 may perform the method 150. In some embodiments, the method 150 may be implemented by executing instructions stored in a tangible, non-transitory, computer-readable medium, such as the memory 54 or secure memory of the device controller 44, using the device controller 44. While the method 150 is described using steps in a specific sequence, it should be understood that the present disclosure contemplates that the described steps may be performed in different sequences than the sequence illustrated, and certain described steps may be skipped or not performed altogether.

At process block 152, the device controller 44 may enter a provisioning mode. For example, the provisioning mode may be an operational state in which the integrated circuit device 12 is preparing to receive and/or load configuration data, such as a bitstream. For example, a provisioning entity (e.g., the end user 74) may cause the device controller 44 to enter the provisioning mode by providing the public key 94 to be provisioned by the device controller 44. At process block 154, the device controller 44 may generate the random nonce (e.g., challenge) as part of the challenge response protocol. The challenge response protocol may enable the device controller 44 to verify an identity of the provisioning entity and/or to enable secure provisioning of the integrated circuit device 12.

At process block 156, the device controller 44 may transmit (e.g., provide) the random nonce to the provisioning entity for signature with the private key 96. For example, the provisioning entity may receive the random nonce, hash the random nonce, and encrypt the hash of the random nonce with the private key 96. The provisioning entity may then transmit the signed random nonce to the device controller 44. At process block 158, the device controller 44 may receive the signed random nonce.

Further, at process block 160, the device controller 44 may verify the signed random nonce using the public key 94 (e.g., stored at the device controller 44). By verifying the signed random nonce, the device controller 44 may determine that the provisioning entity is in possession of the private key 96 that corresponds to the public key 94. For example, as described above, the device controller 44 may determine if a hash of the signed random nonce matches a hash of the random nonce originally transmitted to the provisioning entity. The device controller 44 may verify the signed random nonce if the hash of the signed random nonce does match (e.g., is the same as) the hash of the random nonce originally transmitted to the provisioning entity.

At process block 162, the device controller 44 may verify a hash of the public key 94 that is stored at the device controller 44 matches a hash of the public key 94 that is to be provisioned (e.g., provided by the provisioning entity). For example, the device controller 44 may check if each value of the hash of the public key 94 that is stored matches each value of the hash of the public key 94 that is to be provisioned. At process block 164, the device controller 44 may set the validation value to the public key 94 to be provisioned based on the match between the hashes described above.

FIG. 6 is a flowchart of a method 180 for loading the bitstream 90 for configuration of the integrated circuit device 12. For example, the device controller 44 of the integrated circuit device 12 may perform the method 180. In some embodiments, the method 180 may be implemented by executing instructions stored in a tangible, non-transitory, computer-readable medium, such as the memory 54 or secure memory of the device controller 44, using the device controller 44. While the method 180 is described using steps in a specific sequence, it should be understood that the present disclosure contemplates that the described steps may be performed in different sequences than the sequence illustrated, and certain described steps may be skipped or not performed altogether.

At process block 182, the device controller 44 may receive the bitstream 90. For example, the bitstream 90 may contain configuration data that defines logic and/or routing for the integrated circuit device 12. As another example, the bitstream 90 may be generated by a designer (e.g., the customer 72). At process block 184, the device controller 44 may verify the signature 102 of the bitstream 90. As described above, the signature 102 may be generated based on the private key 96. Therefore, the device controller 44 may verify the signature 102 based on determining that the public key 94 stored on the device controller 44 (e.g., provisioned by the end user 74) corresponds to the private key 96 associated with the signature 102.

As described herein, the bitstream 90 may include the one or more watermarks encoded into the bitstream 90. Thus, at process block 186, the device controller 44 may detect the first watermark in the bitstream 90 containing the transformation of the public key 94. At process block 188, the device controller 44 may determine whether the first watermark corresponds to the public key 94 stored on the device controller 44. For example, the device controller 44 may retrieve fragments of the public key 94 in the first watermark and compare a hash of the fragments of the public key 94 to the hash of the public key 94 stored on the device controller 44.

If the first watermark corresponds to the public key 94 stored on the device controller 44, then the device controller 44 may proceed to process block 190. At process block 190, the device controller 44 may detect the second watermark in the bitstream 90 indicating that a valid public key must be used for configuration of the bitstream 90. Therefore, at process block 190, the device controller 44 may determine whether the validation value is set. To elaborate, the device controller 44 may determine whether the validation value is set in response to detecting the second watermark in the bitstream 90 indicating that the valid public key must be used. If the validation value is set, the device controller 44 may proceed to process block 192. At process block 192, the device controller 44 may load the bitstream 90 for configuration of the integrated circuit device 12.

With the foregoing in mind, and referring back to process block 188, if the device controller 44 determines that the first watermark does not correspond to the public key 94 stored on the device controller 44, then the device controller 44 may proceed to process block 196. At process block 196, the device controller 44 may not load the bitstream 90 for configuration of the integrated circuit device 12. Moreover, with the foregoing in mind, and referring back to process block 192, if the device controller 44 determines that the validation value is not set, then the device controller 44 may proceed to process block 198. At process block 198, the device controller 44 may not load the bitstream 90 for configuration of the integrated circuit device 12.

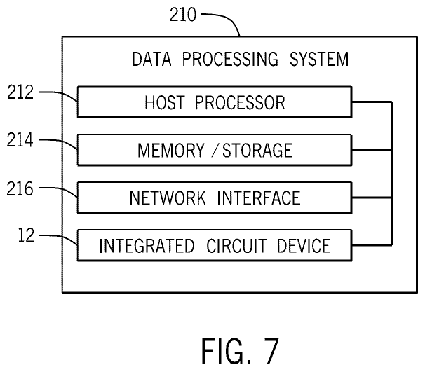

The integrated circuit device 12 discussed above may be a component included in a data processing system, such as a data processing system 210, shown in FIG. 7. The data processing system 210 may include the integrated circuit device 12 (e.g., a programmable logic device, an application specific integrated circuit (ASIC)), a host processor 212, memory and/or storage circuitry 214, and a network interface 216. The data processing system 210 may include more or fewer components (e.g., electronic display, user interface structures, application specific integrated circuits (ASICs)). Moreover, any of the circuit components depicted in FIG. 7 may include the NOC 46 of the integrated circuit device 12. The host processor 212 may include any of the foregoing processors that may manage a data processing request for the data processing system 210 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 214 may include random access memory (RAM), read-only memory (ROM), one or more hard drives, flash memory, or the like. The memory and/or storage circuitry 214 may hold data to be processed by the data processing system 210. In some cases, the memory and/or storage circuitry 214 may also store configuration programs (e.g., bitstreams) for programming the integrated circuit device 12. The network interface 216 may allow the data processing system 210 to communicate with other electronic devices. The data processing system 210 may include several different packages or may be contained within a single package on a single package substrate. For example, components of the data processing system 210 may be located on several different packages at one location (e.g., a data center) or multiple locations. For instance, components of the data processing system 210 may be located in separate geographic locations or areas, such as cities, states, or countries.

The data processing system 210 may be part of a data center that processes a variety of different requests. For instance, the data processing system 210 may receive a data processing request via the network interface 216 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. To provide only a few examples, these may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

### EXAMPLE EMBODIMENTS

EXAMPLE EMBODIMENT 1. An integrated circuit device including programmable logic circuitry, and a controller including a memory, the controller configurable to receive a bitstream, verify a digital signature of the bitstream based on a private key, detect a first watermark and a second watermark of the bitstream based on the verification, wherein the first watermark is associated with a first public key and the second watermark is associated with a validation value stored in one-time programmable memory on the integrated circuit device, determine that the first public key corresponds to a second public key stored in the memory of the controller, and determine that the first public key of the bitstream is validated based on the validation value, and load the bitstream into the programmable logic circuitry based on determining that the first public key corresponds to the second public key and that the first public key is validated.

EXAMPLE EMBODIMENT 2. The integrated circuit device of example embodiment 1, wherein the controller is configurable to store the second public key in the memory by entering a provisioning mode to provision the public key.

EXAMPLE EMBODIMENT 3. The integrated circuit device of example embodiment 2, wherein the controller, while operating in the provisioning mode, is configurable to generate a random nonce, and transmit the random nonce for signature with the private key.

EXAMPLE EMBODIMENT 4. The integrated circuit device of example embodiment 3, wherein the controller, while operating in the provisioning mode, is configurable to receive the signed random nonce, and verify the signed random nonce based on the second public key corresponding to the private key.

EXAMPLE EMBODIMENT 5. The integrated circuit device of example embodiment 3, wherein the controller, while operating in the provisioning mode, is configurable to generate the random nonce as part of a challenge response protocol, wherein the challenge response protocol facilitates secure provisioning.

EXAMPLE EMBODIMENT 6. The integrated circuit device of example embodiment 1, wherein the controller is configurable to verify the digital signature of the bitstream based on determining that the second public key corresponds to the private key associated with the digital signature.

EXAMPLE EMBODIMENT 7. The integrated circuit device of example embodiment 1, wherein the controller is configurable to determine that the first public key corresponds to the second public key based on determining that a hash of the first public key matches a hash of the second public key.

EXAMPLE EMBODIMENT 8. The integrated circuit device of example embodiment 1, wherein the second watermark is indicative of a condition that the first public key is validated prior to loading the bitstream into the programmable logic circuitry.

EXAMPLE EMBODIMENT 9. One or more tangible, non-transitory, machine-readable media including instructions that, when executed by a data processing system, enable the data processing system to perform operations to generate a system design for an integrated circuit device including receiving a random nonce, signing the random nonce based on a private key, transmitting the signed random nonce for verification with a public key, encode a first watermark and a second watermark into a bitstream, wherein the first watermark is associated with the public key and the second watermark is associated with a validation value, and transmit the bitstream.

EXAMPLE EMBODIMENT 10. The one or more tangible, non-transitory, machine-readable media of example embodiment 9, wherein the instructions, when executed by the data processing system, enable the data processing system to perform operations to cause the integrated circuit device to enter a provisioning mode to provision the public key.

EXAMPLE EMBODIMENT 11. The one or more tangible, non-transitory, machine-readable media of example embodiment 10, wherein the instructions, when executed by the data processing system, enable the data processing system to perform operations to receive the random nonce based on the integrated circuit device entering the provision mode.

EXAMPLE EMBODIMENT 12. The one or more tangible, non-transitory, machine-readable media of example embodiment 9, wherein the instructions, when executed by the data processing system, enable the data processing system to perform operations to sign the bitstream with a digital signature based on the private key.

EXAMPLE EMBODIMENT 13. The one or more tangible, non-transitory, machine-readable media of example embodiment 9, wherein the first watermark includes a transformation of the public key.

EXAMPLE EMBODIMENT 14. The one or more tangible, non-transitory, machine-readable media of example embodiment 9, wherein the validation value is indicative of a condition that the public key is validated.

EXAMPLE EMBODIMENT 15. A method including receiving a bitstream including a signature associated with a private key, detecting a first watermark of the bitstream, wherein the first watermark is associated with a first public key, and loading the bitstream based on determining that the first public key corresponds to a second public key and the private key and that the first public key is validated based on a validation value.

EXAMPLE EMBODIMENT 16. The method of example embodiment 15, including detecting a second watermark of the bitstream, wherein the second watermark is associated with the validation value.

EXAMPLE EMBODIMENT 17. The method of example embodiment 15, including storing the second public key by entering a provisioning mode to provision the public key.

EXAMPLE EMBODIMENT 18. The method of example embodiment 17, including generating a random nonce in response to entering the provisioning mode, and transmitting the random nonce for the signature associated with the private key.

EXAMPLE EMBODIMENT 19. The method of example embodiment 15, including verifying a digital signature of the bitstream by determining that the second public key corresponds to the private key.

EXAMPLE EMBODIMENT 20. The method of example embodiment 15, including determining that the first public key corresponds to the second public key by determining that a hash of the first public key matches a hash of the second public key.

What is claimed is:

1. An integrated circuit device comprising:
programmable logic circuitry; and
a controller comprising a memory, the controller configurable to:
receive a bitstream;
verify a digital signature of the bitstream based on a private key;
detect a first watermark and a second watermark of the bitstream based on the verification, wherein the first watermark is associated with a first public key and the second watermark is associated with a validation value stored in one-time programmable memory on the integrated circuit device;
determine that the first public key corresponds to a second public key stored in the memory of the controller;
determine that the first public key of the bitstream is validated based on the validation value; and
load the bitstream into the programmable logic circuitry based on determining that the first public key corresponds to the second public key and that the first public key is validated.

2. The integrated circuit device of claim 1, wherein the controller is configurable to store the second public key in the memory by entering a provisioning mode to provision the public key.

3. The integrated circuit device of claim 2, wherein the controller, while operating in the provisioning mode, is configurable to:
generate a random nonce; and
transmit the random nonce for signature with the private key.

4. The integrated circuit device of claim 3, wherein the controller, while operating in the provisioning mode, is configurable to:
receive the signed random nonce; and
verify the signed random nonce based on the second public key corresponding to the private key.

5. The integrated circuit device of claim 3, wherein the controller, while operating in the provisioning mode, is configurable to generate the random nonce as part of a challenge response protocol, wherein the challenge response protocol facilitates secure provisioning.

6. The integrated circuit device of claim 1, wherein the controller is configurable to verify the digital signature of the bitstream based on determining that the second public key corresponds to the private key associated with the digital signature.

7. The integrated circuit device of claim 1, wherein the controller is configurable to determine that the first public key corresponds to the second public key based on determining that a hash of the first public key matches a hash of the second public key.

8. The integrated circuit device of claim 1, wherein the second watermark is indicative of a condition that the first public key is validated prior to loading the bitstream into the programmable logic circuitry.

9. One or more tangible, non-transitory, machine-readable media comprising instructions that, when executed by a data processing system, enable the data processing system to perform operations to generate a system design for an integrated circuit device comprising:
receiving a random nonce;
signing the random nonce based on a private key;
transmitting the signed random nonce for verification with a public key;
encode a first watermark and a second watermark into a bitstream, wherein the first watermark is associated with the public key and the second watermark is associated with a validation value; and
transmit the bitstream.

10. The one or more tangible, non-transitory, machine-readable media of claim 9, wherein the instructions, when executed by the data processing system, enable the data processing system to perform operations to cause the integrated circuit device to enter a provisioning mode to provision the public key.

11. The one or more tangible, non-transitory, machine-readable media of claim 10, wherein the instructions, when executed by the data processing system, enable the data processing system to perform operations to receive the random nonce based on the integrated circuit device entering the provision mode.

12. The one or more tangible, non-transitory, machine-readable media of claim 9, wherein the instructions, when executed by the data processing system, enable the data processing system to perform operations to sign the bitstream with a digital signature based on the private key.

13. The one or more tangible, non-transitory, machine-readable media of claim 9, wherein the first watermark comprises a transformation of the public key.

14. The one or more tangible, non-transitory, machine-readable media of claim 9, wherein the validation value is indicative of a condition that the public key is validated.

15. A method comprising:
receiving a bitstream comprising a signature associated with a private key;
detecting a first watermark of the bitstream, wherein the first watermark is associated with a first public key; and
loading the bitstream based on determining that the first public key corresponds to a second public key and the private key and that the first public key is validated based on a validation value.

16. The method of claim 15, comprising detecting a second watermark of the bitstream, wherein the second watermark is associated with the validation value.

17. The method of claim 15, comprising storing the second public key by entering a provisioning mode to provision the public key.

18. The method of claim 17, comprising:
generating a random nonce in response to entering the provisioning mode; and
transmitting the random nonce for the signature associated with the private key.

19. The method of claim 15, comprising verifying a digital signature of the bitstream by determining that the second public key corresponds to the private key.

20. The method of claim 15, comprising determining that the first public key corresponds to the second public key by determining that a hash of the first public key matches a hash of the second public key.
